(19) United States
(12) Patent Application Publication
(10) Pub. No.: US 2026/0219725 A1
(43) Pub. Date: Jul. 30, 2026

(54) CONTEXT PREDICTION DEVICE, CONTEXT PREDICTION METHOD, AND RECORDING MEDIUM

(71) Applicant: NEC Corporation, Tokyo (JP)

(72) Inventor: Keisuke KANEYASU, Tokyo (JP)

(73) Assignee: NEC Corporation, Tokyo (JP)

(21) Appl. No.: 19/146,070

(22) PCT Filed: Mar. 17, 2023
(86) PCT No.: PCT/JP2023/010568

§ 371 Date: Jul. 7, 2025

(51) Int. Cl. G06F 3/01

(52) U.S. Cl. CPC G06F 3/011; G06F 2203/011

(57) ABSTRACT

In the context prediction device, the state information acquisition means acquires state information regarding a plurality of avatars and a plurality of virtual objects. The motion information acquisition means acquires motion information regarding the plurality of avatars and the plurality of virtual objects by user operations. The behavior recognition means recognizes behaviors of the plurality of avatars based on the state information and the motion information. The prediction means predicts contexts regarding the behaviors of the plurality of avatars based on the state information, the motion information, and the behaviors of the plurality of avatars.

### TECHNICAL FIELD

The present disclosure relates to context prediction in cyberspace.

### BACKGROUND ART

In recent years, cyberspace is becoming more and more prevalent, and a plurality of users can interact with each other on a network as in a real world. In order to make communication in the cyberspace smoother, for example, Patent Document 1 proposes a method of thoroughly ensuring manners of users in a virtual space.

### PRECEDING TECHNICAL REFERENCE

### Patent Document

Patent Document 1: JP 2003-199970 A

### SUMMARY

### Problem to be Solved

In Patent Document 1, a user who does not observe the manners is discriminated in accordance with a predefined code of behavior. However, since various types of information such as an avatar, an object, a sound, and a design exist in the cyberspace, meaning of behavior of an avatar may be different depending on a combination of the behavior and a surrounding state at that time even when the avatar is performing the same behavior. Therefore, even when a user operates an avatar in accordance with the code of behavior, there is a possibility that it may be an unfair act depending on a surrounding state at that time, and that the communication in the cyberspace is hindered.

It is an example object of the present disclosure to provide a context prediction device capable of predicting a context of an avatar in cyberspace.

### Means for Solving the Problem

According to an example aspect of the present disclosure, there is provided a context prediction device, comprising:
state information acquisition means for acquiring state information regarding a plurality of avatars and a plurality of virtual objects;
motion information acquisition means for acquiring motion information regarding the plurality of avatars and the plurality of virtual objects by user operations;
behavior recognition means for recognizing behaviors of the plurality of avatars based on the state information and the motion information; and
prediction means for predicting contexts regarding the behaviors of the plurality of avatars based on the state information, the motion information, and the behaviors of the plurality of avatars.

According to another example aspect of the present disclosure, there is provided a context prediction method comprising:
acquiring state information regarding a plurality of avatars and a plurality of virtual objects;
acquiring motion information regarding the plurality of avatars and the plurality of virtual objects by user operations;
recognizing behaviors of the plurality of avatars based on the state information and the motion information; and
predicting contexts regarding the behaviors of the plurality of avatars based on the state information, the motion information, and the behaviors of the plurality of avatars.

According to a further example aspect of the present disclosure, there is provided a recording medium recording a program for causing a computer to execute processing comprising:
acquiring state information regarding a plurality of avatars and a plurality of virtual objects;
acquiring motion information regarding the plurality of avatars and the plurality of virtual objects by user operations;
recognizing behaviors of the plurality of avatars based on the state information and the motion information; and
predicting contexts regarding the behaviors of the plurality of avatars based on the state information, the motion information, and the behaviors of the plurality of avatars.

### Effect

According to the present disclosure, it is possible to predict a context of an avatar in cyberspace.

### BRIEF DESCRIPTION OF THE DRAWINGS

FIG. 1 illustrates an overall configuration of a cyberspace management system according to a first example embodiment.

FIG. 2 is a block diagram illustrating a configuration of a server.

FIG. 3 is a block diagram illustrating a functional configuration of the server.

FIGS. 4(A) and 4(B) are diagrams for describing an example of context prediction by a context prediction model.

FIG. 5 is a flowchart of context prediction processing according to the first example embodiment.

FIG. 6 is a block diagram illustrating a functional configuration of a server according to a second example embodiment.

FIG. 7 is a diagram for describing an example of context prediction by a context prediction model according to the second example embodiment.

FIG. 8 is a flowchart of context prediction processing according to the second example embodiment.

FIG. 9 is a block diagram illustrating a functional configuration of a context prediction device of a third example embodiment.

FIG. 10 is a flowchart of processing by the context prediction device of the third example embodiment.

### EXAMPLE EMBODIMENTS

Hereinafter, preferred example embodiments of the present disclosure will be described with reference to the drawings.

### First Example Embodiment

### [System Configuration]

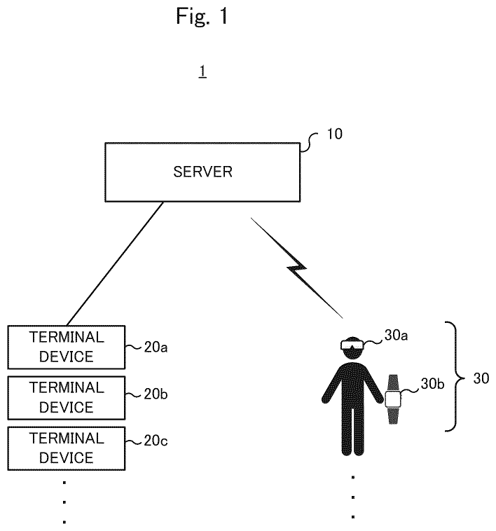

FIG. 1 illustrates an overall configuration of a cyberspace management system to which a context prediction device according to the present disclosure is applied. A cyberspace management system 1 includes a server 10, terminal devices 20 used by users, and wearable devices 30 used by the users. The server 10 is an example of the context prediction device.

It is assumed that there is the plurality of terminal devices 20, and subscripts are added to the terminal devices 20 when the individual terminal devices are distinguished, and the plurality of terminal devices 20 is simply referred to as the “terminal devices 20” when not being distinguished. Similarly, it is assumed that there is the plurality of wearable devices 30, and subscripts are added to the wearable devices 30 when the individual terminal devices are distinguished, and the plurality of wearable devices 30 is simply referred to as the “wearable devices 30” when not being distinguished. The server 10 and the terminal devices 20 can communicate with each other in a wired or wireless manner, and the server 10 and the wearable devices 30 can communicate with each other in a wired or wireless manner.

In the cyberspace management system 1, by the server 10 transmitting data of cyberspace to the terminal devices 20 in response to requests of the terminal devices 20, a place for communication among users is provided. In the present example embodiment, a virtual office as a virtual office space will be described as an example of the cyberspace provided by the cyberspace management system 1, but the cyberspace provided by the cyberspace management system 1 is not limited to this, and may be any cyberspace as long as it provides the place for the communication among the users.

Specifically, the server 10 draws virtual objects such as a desk, a chair, and a meeting room according to setting information prepared in advance, and generates data of the virtual office. When a user accesses the server 10 using the terminal device 20 and logs in to the virtual office, the server 10 generates an avatar based on login information regarding the user and arranges the avatar in the virtual office. The server 10 then transmits the data of the virtual office to the terminal device 20.

The terminal device 20 is a terminal device such as a personal computer (PC) or a tablet. The user of the terminal device 20 acquires the data of the virtual office and displays the data on a display or the like, in such a way that the user can experience that the user is in the virtual office. The user can move his/her own avatar or communicate with an avatar of another user by operating his/her own avatar by using the terminal device 20.

The wearable device 30 is a terminal having a function of acquiring position information, biological information, and the like regarding the user, and is, for example, a terminal device such as a smartphone, a smart watch, or a smart glass. Examples of the biological information regarding the user include a body temperature, a heart rate, a pulse, a line of sight, and a voice. The wearable device 30 transmits the position information, the biological information, and the like to the server 10 at predetermined timings. The position information, the biological information, and the like of the user in a real space are hereinafter also referred to as “multimodal information”.

In the present example embodiment, the server 10 further predicts a context of the avatar. The context is an evaluation of a third party's point of view on the avatar. In other words, the context indicates what kind of impression a third party has when seeing a state or behavior of the avatar. Specifically, the server 10 predicts the context of the avatar based on a combination of state information regarding the avatar or a virtual object (hereinafter, also simply referred to as “state information”), motion information regarding the avatar (hereinafter, also simply referred to as “motion information”), the multimodal information, and the like. The state information includes information such as a position, a shape, a color, a size, hardness, and a weight of the avatar or the virtual object. The motion information includes information regarding an operation performed on the avatar by the user (hereinafter, also referred to as “operation information”), information regarding a conversation between the avatars, and the like.

The server 10 determines whether a content of the predicted context is positive or negative. The context being positive indicates that the content of the context gives a good impression to the third party. The context being negative indicates that the content of the context gives a bad impression to the third party. In a case where the context is negative, the server 10 may perform notification to the user who operates the corresponding avatar or a system administrator. With this arrangement, the user or the system administrator can grasp that there is a problem in the state or behavior of the corresponding avatar.

### [Hardware Configuration]

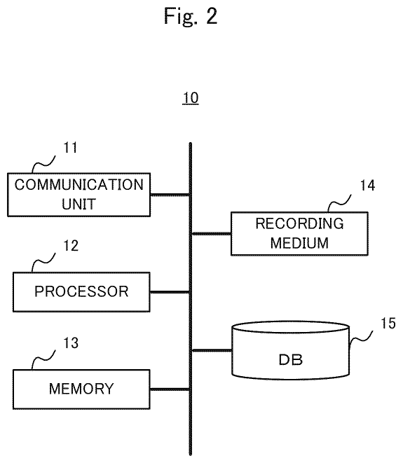

FIG. 2 is a block diagram illustrating a hardware configuration of the server 10. The server 10 mainly includes a communication unit 11, a processor 12, a memory 13, a recording medium 14, and a database (DB) 15.

The communication unit 11 transmits and receives data to and from an external device. Specifically, the communication unit 11 transmits and receives information to and from the terminal device 20 and the wearable device 30.

The processor 12 is a computer such as a central processing unit (CPU), and controls the entire server 10 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), and the like. The memory 13 stores various programs executed by the processor 12. The memory 13 is also used as a work memory during execution of various types of processing by the processor 12.

The recording medium 14 is a non-volatile non-transitory recording medium such as a disk-shaped recording medium or a semiconductor memory, and is attachable to and detachable from the server 10. The recording medium 14 records various programs executed by the processor 12.

The database (DB) 15 stores information regarding a user, information regarding cyberspace, a history of state information, a history of motion information, a history of multimodal information, and the like. The information regarding the cyberspace includes, for example, information such as coordinates and a display form of a virtual object. The DB 15 may include an external storage device such as a hard disk connected to or built in the server 10, or may include a storage medium such as a freely attachable and detachable flash memory. Instead of providing the DB 15 in the server 10, the DB 15 may be provided in an external server or the like, and the information regarding the user, the information regarding the cyberspace, the history of the state information, the history of the motion information, the history of the multimodal information, and the like may be stored in the server by communication.

The server 10 may include an input unit such as a keyboard and a mouse for the administrator or the like to perform instruction and input, and a display unit such as a liquid crystal display.

### [Functional Configuration]

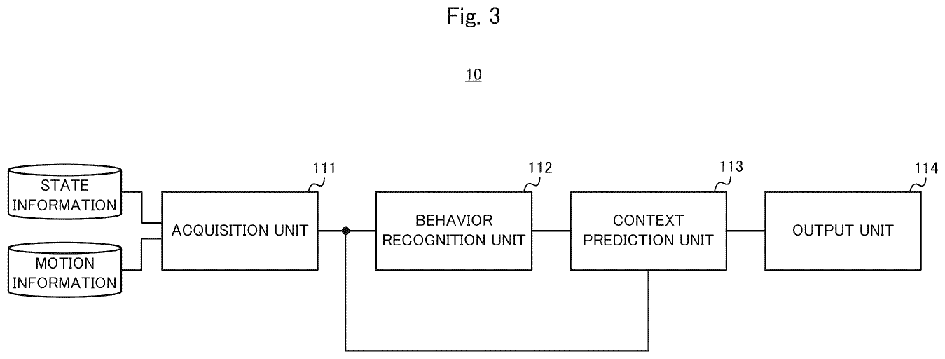

FIG. 3 is a block diagram illustrating a functional configuration of the server 10 according to the first example embodiment. The server 10 functionally includes an acquisition unit 111, a behavior recognition unit 112, a context prediction unit 113, and an output unit 114, in addition to the DB 15 described above.

The server 10 collects the state information and the motion information at predetermined timings, and stores the state information and the motion information in the DB 15. The acquisition unit 111 acquires the state information and the motion information from the DB 15. The acquisition unit 111 outputs the state information and the motion information to the behavior recognition unit 112 and the context prediction unit 113.

The behavior recognition unit 112 receives the input of the state information and the motion information from the acquisition unit 111. The behavior recognition unit 112 estimates a behavior of an avatar based on the state information and the motion information.

Specifically, the behavior recognition unit 112 estimates the behavior of the avatar using a behavior recognition model or the like prepared in advance. The behavior recognition model is a machine learning model trained in advance using learning data in which a combination of the state information and the motion information is associated with a behavior for the combination. For example, the behavior recognition model can estimate the behavior of the avatar such as “holding a virtual object” or “throwing a virtual object” from a combination of a change in a position of the virtual object (state information) and operation information regarding the avatar (motion information).

The behavior recognition model used by the behavior recognition unit 112 is not limited to the above. The behavior recognition model may be a machine learning model trained in advance using learning data generated by labeling, for a large number of videos in the cyberspace, behaviors of avatars included in the videos. In the case of using this model, first, the behavior recognition unit 112 reproduces a virtual office in a predetermined time zone with a video based on the state information and the motion information. The behavior recognition unit 112 then detects the avatar from the reproduction video using the behavior recognition model, and estimates the behavior of the avatar.

The behavior recognition unit 112 outputs the estimated behavior of the avatar to the context prediction unit 113.

The context prediction unit 113 receives the input of the state information and the motion information from the acquisition unit 111 and receives the input of the behavior of the avatar from the behavior recognition unit 112. The context prediction unit 113 predicts a context based on the state information, the motion information, and the behavior of the avatar.

Specifically, the context prediction unit 113 predicts the context of the avatar using a context prediction model prepared in advance. The context prediction model is a machine learning model trained in advance to output a context based on state information, motion information, and behaviors of a plurality of avatars. The context prediction model is generated by, for example, supervised learning. As learning data, data is used in which contexts are labeled in advance with respect to a combination of the state information, the motion information, and the behaviors of the plurality of avatars.

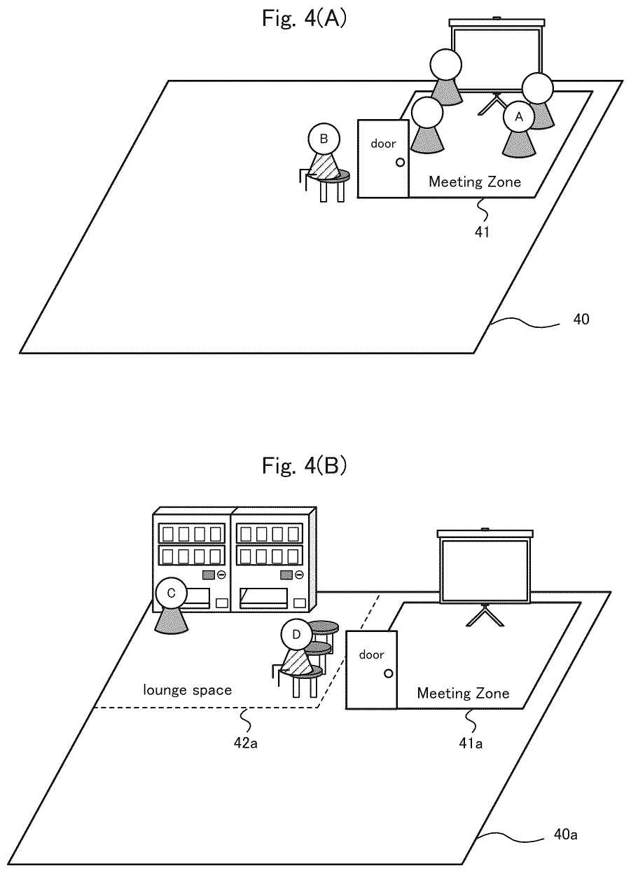

FIGS. 4(A) and 4(B) are diagrams for describing an example of context prediction by the context prediction model.

In FIG. 4(A), a meeting zone 41, an avatar A, and an avatar B are included in a virtual office 40. In FIG. 4(A), there is a chair near the meeting zone 41, and the avatar B is performing a behavior of “sitting on a chair”. In the meeting zone 41, it is assumed that a plurality of avatars including the avatar A have a confidential meeting. In this case, from a user of the avatar A, the avatar B seems to be eavesdropping on contents of the meeting.

In FIG. 4(B), a meeting zone 41a, an avatar C, an avatar D, and a lounge space 42a are included in a virtual office 40a. In FIG. 4(B), there is a chair in the lounge space 42a, and the avatar D is performing a behavior of “sitting on a chair”. It is assumed that the avatar C purchases a beverage in the lounge space 42a. In this case, from a user of the avatar C, the avatar D seems to be taking a break.

In the situation of FIG. 4(A), the context prediction model predicts a context such as “eavesdropping on a meeting” for the avatar B. In the situation of FIG. 4(B), the context prediction model predicts a context such as “taking a break” for the avatar D. In this manner, even with the same behavior of “sitting on a chair”, the different contexts are predicted depending on the surrounding situations (state information regarding the avatar or the virtual object, motion information regarding the plurality of avatars, and the behaviors of the plurality of avatars).

Returning to FIG. 3, the context prediction unit 113 determines whether the context is positive or negative based on the predicted context. For example, the context prediction unit 113 may determine whether the predicted context is positive or negative with reference to a table or the like in which negative contexts are determined in advance. In this case, in a case where the predicted context is included in the table, the context prediction unit 113 determines that the predicted context is negative. On the other hand, in a case where the predicted context is not included in the table, the context prediction unit 113 determines that the predicted context is positive.

The context prediction unit 113 may determine whether the predicted context is positive or negative using a machine learning model trained in advance using learning data generated by labeling a large number of contexts positive or negative.

The context prediction unit 113 outputs the context and a determination result of the context to the output unit 114.

The output unit 114 receives the input of the context and the determination result of the context from the context prediction unit 113. The output unit 114 outputs the input context and the input determination result of the context to the DB 15. In a case where the determination result of the context is negative, the output unit 114 may perform notification to a user who is operating the target avatar and the system administrator. In a case where the determination result of the context is positive, the output unit 114 may give an incentive to the user who is operating the target avatar. Examples of the incentive include an in-house point used in personnel evaluation.

In the above configuration, the acquisition unit 111 is an example of state information acquisition means and motion information acquisition means, the behavior recognition unit 112 is an example of behavior recognition means, and the context prediction unit 113 and the output unit 114 are examples of prediction means.

### [Context Prediction Processing]

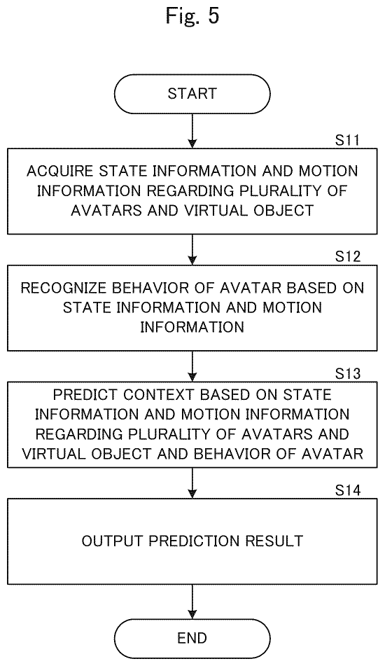

Next, context prediction processing of performing the prediction as described above will be described. FIG. 5 is a flowchart of the context prediction processing by the server 10. This processing is achieved by the processor 12 illustrated in FIG. 2 executing a program prepared in advance and operating as each element illustrated in FIG. 3.

First, the acquisition unit 111 acquires state information and motion information from the DB 15. The acquisition unit 111 outputs the state information and the motion information to the behavior recognition unit 112 and the context prediction unit 113 (step S11).

Next, the behavior recognition unit 112 estimates a behavior of an avatar based on the state information and the motion information. The behavior recognition unit 112 outputs the estimated behavior of the avatar to the context prediction unit 113 (step S12). Specifically, the behavior recognition unit 112 estimates the behavior of the avatar using the behavior recognition model.

The context prediction unit 113 predicts a context based on the state information, the motion information, and the behavior of the avatar. The context prediction unit 113 outputs the predicted context to the output unit 114 (step S13). Specifically, the context prediction unit 113 predicts the context using the context prediction model. The context prediction model is a machine learning model trained to output a context based on state information, motion information, and behaviors of a plurality of avatars. The context prediction unit 113 determines whether the predicted context is positive or negative, and outputs a determination result to the output unit 114.

The output unit 114 outputs the context and the determination result of the context to the DB 15 (step S14), and the processing ends. In a case where the determination result of the context is negative, the output unit 114 may perform notification to a user who is operating the target avatar and a system administrator. In a case where the determination result of the context is positive, the output unit 114 may give an incentive to the user who is operating the target avatar.

### [Modification]

Next, a modification of the first example embodiment will be described.

### (Modification)

In the first example embodiment, the context prediction unit 113 determines whether the predicted context is positive or negative based on the content of the predicted context. In a case where the determination by the above method is difficult, the context prediction unit 113 may determine whether the predicted context is positive or negative in consideration of the multimodal information.

Specifically, the context prediction unit 113 estimates an emotion of the user who operates the avatar for which the context is to be predicted (hereinafter, also referred to as the “target avatar”) and an emotion of a user who operates an avatar near the target avatar (hereinafter, also referred to as a “nearby avatar”), and determines whether the context is positive or negative using each estimation result. For example, the context prediction unit 113 estimates the emotion of the user who operates the target avatar and the emotion of the user who operates the nearby avatar by using an emotion estimation model or the like prepared in advance. The emotion estimation model is a machine learning model trained in advance in such a way as to use the multimodal information as an input and which emotion the multimodal information corresponds to among a plurality of emotions determined in advance as an output. The context prediction unit 113 then refers to a table in which a combination of the emotion of the user who operates the target avatar and the emotion of the user who operates the nearby avatar is associated with information indicating whether the combination is positive or negative, and determines whether the predicted context is positive or negative.

The context prediction unit 113 may determine whether the predicted context is positive or negative using a machine learning model trained in advance using learning data generated by labeling a large number of pieces of the multimodal information positive or negative.

### Second Example Embodiment

Next, a second example embodiment will be described. A server 10a according to the second example embodiment is different from the server 10 according to the first example embodiment in that a context is predicted using multimodal information. The server 10a according to the second example embodiment has a hardware configuration similar to that of the server 10 according to the first example embodiment, and thus description thereof will be omitted.

### [Functional Configuration]

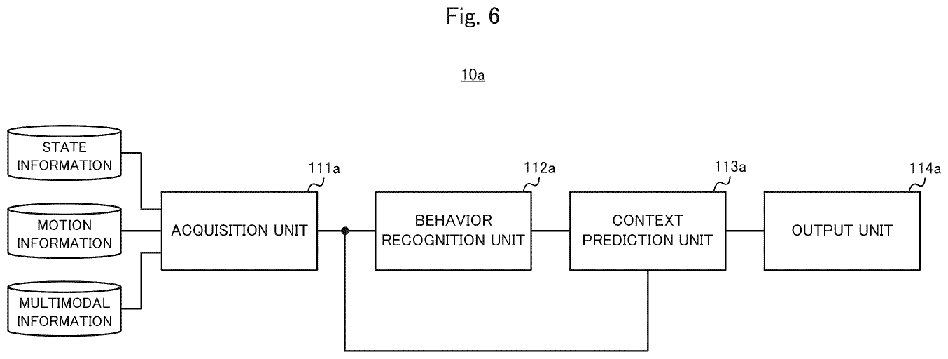

FIG. 6 is a block diagram illustrating a functional configuration of the server 10a according to the second example embodiment. The server 10a functionally includes an acquisition unit 111a, a behavior recognition unit 112a, a context prediction unit 113a, and an output unit 114a, in addition to the DB 15 described above. The behavior recognition unit 112a and the output unit 114a have configurations similar to those of the behavior recognition unit 112 and the output unit 114 of the server 10 according to the first example embodiment, and operate in a similar manner, and thus description thereof will be omitted.

The server 10a receives multimodal information from a wearable device 30 through a communication unit 11. The acquisition unit 111a acquires the multimodal information, and outputs the multimodal information to the context prediction unit 113a. The acquisition unit 111a acquires state information and motion information from the DB 15. The acquisition unit 111a outputs the state information and the motion information to the behavior recognition unit 112a and the context prediction unit 113a.

The context prediction unit 113a receives the input of the state information, the motion information, and the multimodal information from the acquisition unit 111a, and receives an input of a behavior of an avatar from the behavior recognition unit 112a. The context prediction unit 113a predicts a context based on the state information, the motion information, the multimodal information, and the behavior of the avatar.

Specifically, the context prediction unit 113a predicts the context of the avatar using a context prediction model prepared in advance. The context prediction model is a machine learning model trained in advance to output a context based on state information, motion information, behaviors of a plurality of avatars, and multimodal information. The context prediction model is generated by, for example, supervised learning. As learning data, data is used in which contexts are labeled in advance with respect to a combination of the state information, the motion information, the behaviors of the plurality of avatars, and the multimodal information.

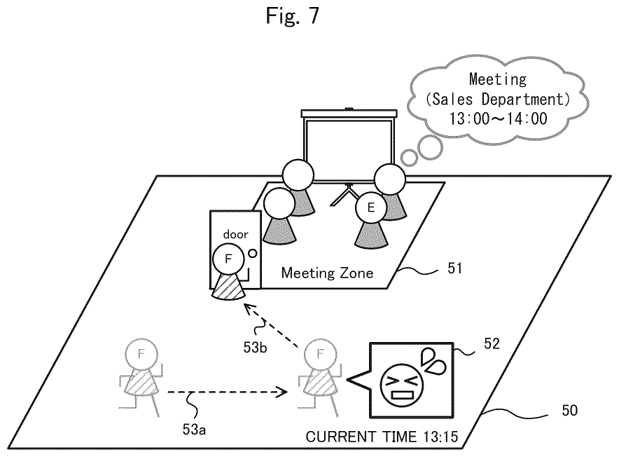

FIG. 7 is a diagram for describing an example of context prediction by the context prediction model according to the second example embodiment.

In FIG. 7, a meeting zone 51, an avatar E, an avatar F, and multimodal information 52 are included in a virtual office 50. The multimodal information 52 indicates that a heart rate of a user who operates the avatar F is high. In the meeting zone 51, a meeting is held from 13:00 to 14:00, and a current time is 13:15. Now, it is assumed that the avatar F has moved along an arrow 53a and an arrow 53b and has arrived at an entrance of the meeting zone 51.

In a case where the multimodal information 52 is not considered, from a user of the avatar E, the avatar F seems to have passed the entrance and then returned to the entrance again to enter the meeting zone 51. On the other hand, in a case where the multimodal information 52 is considered, from the user of the avatar E, the avatar F seems to have rushed to the meeting zone 51 in a hurry. In the situation of FIG. 7, the context prediction model according to the second example embodiment can predict a context such as “rushed to a meeting in a hurry” for the avatar F. In this manner, by using the multimodal information, the context prediction unit 113a can predict the context reflecting the state of the user in a real space.

Returning to FIG. 6, the context prediction unit 113a determines whether the context is positive or negative based on the predicted context. For example, the context prediction unit 113a may determine whether the predicted context is positive or negative with reference to a table or the like in which negative contexts are determined in advance. In this case, in a case where the predicted context is included in the table, the context prediction unit 113a determines that the predicted context is negative. On the other hand, in a case where the predicted context is not included in the table, the context prediction unit 113a determines that the predicted context is positive.

The context prediction unit 113a may determine whether the predicted context is positive or negative using a machine learning model trained in advance using learning data generated by labeling a large number of contexts positive or negative.

In a case where the determination by the above method is difficult, the context prediction unit 113a may determine whether the predicted context is positive or negative in consideration of the multimodal information. Specifically, the context prediction unit 113a estimates an emotion of a user who operates the target avatar and an emotion of a user who operates a nearby avatar, and determines whether the context is positive or negative using each estimation result. For example, the context prediction unit 113a estimates the emotion of the user who operates the target avatar and the emotion of the user who operates the nearby avatar by using an emotion estimation model or the like prepared in advance. The emotion estimation model is a machine learning model trained in advance in such a way as to use the multimodal information as an input and which emotion the multimodal information corresponds to among a plurality of emotions determined in advance as an output. The context prediction unit 113a then refers to a table in which a combination of the emotion of the user who operates the target avatar and the emotion of the user who operates the nearby avatar is associated with information indicating whether the combination is positive or negative, and determines whether the predicted context is positive or negative.

The context prediction unit 113a may determine whether the predicted context is positive or negative using a machine learning model trained in advance using learning data generated by labeling a large number of pieces of the multimodal information positive or negative.

The context prediction unit 113a outputs the context and a determination result of the context to the output unit 114a.

### [Context Prediction Processing]

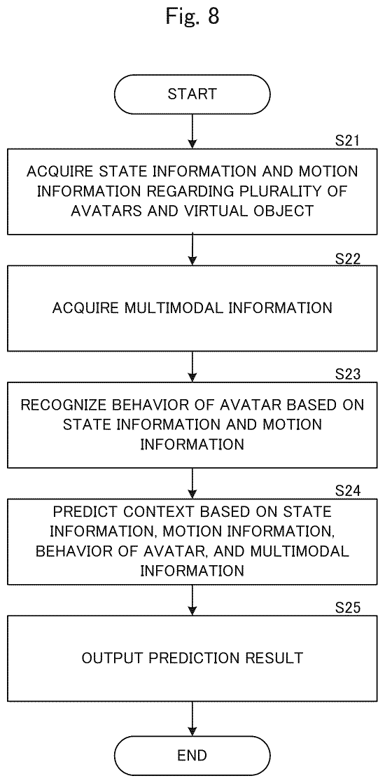

Next, context prediction processing of performing the prediction as described above will be described. FIG. 8 is a flowchart of the context prediction processing by the server 10a. This processing is achieved by the processor 12 illustrated in FIG. 2 executing a program prepared in advance and operating as each element illustrated in FIG. 6. The processing in steps S21, S23, and S25 is similar to the processing in steps S11, S12, and S14 of the first example embodiment illustrated in FIG. 5, and thus description thereof will be omitted.

The server 10a receives multimodal information from the wearable device 30 through the communication unit 11. The acquisition unit 111a acquires the multimodal information, and outputs the multimodal information to the context prediction unit 113a (step S22).

The context prediction unit 113a receives the input of the state information, the motion information, and the multimodal information from the acquisition unit 111a, and receives an input of a behavior of an avatar from the behavior recognition unit 112a. The context prediction unit 113a predicts a context based on the state information, the motion information, the multimodal information, and the behavior of the avatar. The context prediction unit 113a outputs the predicted context to the output unit 114a (step S24). Specifically, the context prediction unit 113a predicts the context using the context prediction model. The context prediction model is a machine learning model trained to output a context based on state information regarding an avatar or a virtual object, motion information regarding a plurality of avatars, behaviors of the plurality of avatars, and multimodal information. The context prediction unit 113a determines whether the predicted context is positive or negative, and output a determination result to the output unit 114a.

### [Modification]

Next, a modification of the second example embodiment will be described.

### (Modification)

In the second example embodiment, the output unit 114a outputs the context and the determination result of the context input from the context prediction unit 113a to the DB 15. In addition, in a case where a word representing a state or an emotion of a user is included in the context, the output unit 114a may reflect the state or emotion in the avatar. For example, in a case where the context input from the context prediction unit 113a is “rushed to a meeting in a hurry”, the output unit 114a may change an expression of the corresponding avatar to a panicking expression, and output the expression to the terminal device 20. The output unit 114a can determine the expression of the avatar by referring to a table or the like in which relationships between words representing states or emotions of users and expressions of avatars are determined in advance. With this arrangement, a third party can grasp a state or an emotion of the user in the real space.

### Third Example Embodiment

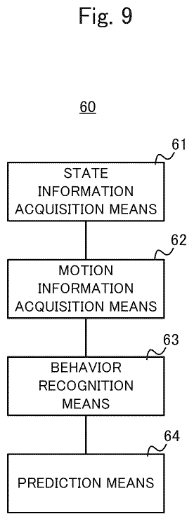

FIG. 9 is a block diagram illustrating a functional configuration of a context prediction device of a third example embodiment. A context prediction device 60 includes state information acquisition means 61, motion information acquisition means 62, behavior recognition means 63, and prediction means 64.

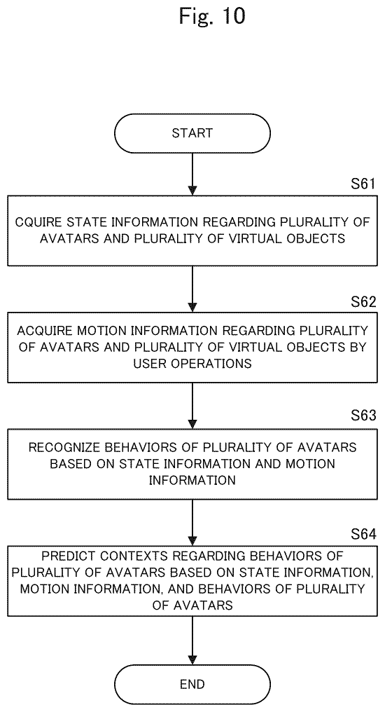

FIG. 10 is a flowchart of processing by the context prediction device of the third example embodiment. The state information acquisition means 61 acquires state information regarding a plurality of avatars and a plurality of virtual objects (step S61). The motion information acquisition means 62 acquires motion information regarding the plurality of avatars and the plurality of virtual objects by user operations (step S62). The behavior recognition means 63 recognizes behaviors of the plurality of avatars based on the state information and the motion information (step S63). The prediction means 64 predicts contexts regarding the behaviors of the plurality of avatars based on the state information, the motion information, and the behaviors of the plurality of avatars (step S64).

According to the context prediction device 60 of the third example embodiment, it is possible to predict the contexts of the avatars in cyberspace.

Some or all of the above example embodiments may also be described as the following Supplementary Notes, but are not limited to the following Supplementary Notes.

### (Supplementary Note 1)

A context prediction device comprising:
state information acquisition means for acquiring state information regarding a plurality of avatars and a plurality of virtual objects;
motion information acquisition means for acquiring motion information regarding the plurality of avatars and the plurality of virtual objects by user operations;
behavior recognition means for recognizing behaviors of the plurality of avatars based on the state information and the motion information; and
prediction means for predicting contexts regarding the behaviors of the plurality of avatars based on the state information, the motion information, and the behaviors of the plurality of avatars.

### (Supplementary Note 2)

The context prediction device according to supplementary note 1, further comprising
multimodal information acquisition means for acquiring multimodal information from a user,
wherein the prediction means predicts the contexts regarding the behaviors of the plurality of avatars based on the state information, the motion information, the behaviors of the plurality of avatars, and the multimodal information.

### (Supplementary Note 3)

The context prediction device according to supplementary note 2, further comprising:
determination means for determining whether a content of the context is positive or negative; and
notification means for performing notification to a system administrator and an avatar that has performed a negative behavior in a case where the content of the context is negative.

### (Supplementary Note 4)

The context prediction device according to supplementary note 3, wherein the notification means gives an incentive to an avatar that has performed a positive behavior in a case where the content of the context is positive.

### (Supplementary Note 5)

The context prediction device according to supplementary note 2, further comprising display control means for estimating a state or an emotion of a user based on the content of the context and reflects the state or the emotion of the user in an avatar.

### (Supplementary Note 6)

A context prediction method comprising:
acquiring state information regarding a plurality of avatars and a plurality of virtual objects;
acquiring motion information regarding the plurality of avatars and the plurality of virtual objects by user operations;
recognizing behaviors of the plurality of avatars based on the state information and the motion information; and
predicting contexts regarding the behaviors of the plurality of avatars based on the state information, the motion information, and the behaviors of the plurality of avatars.

### (Supplementary Note 7)

A recording medium recording a program for causing a computer to execute processing comprising:
acquiring state information regarding a plurality of avatars and a plurality of virtual objects;
acquiring motion information regarding the plurality of avatars and the plurality of virtual objects by user operations;
recognizing behaviors of the plurality of avatars based on the state information and the motion information; and
predicting contexts regarding the behaviors of the plurality of avatars based on the state information, the motion information, and the behaviors of the plurality of avatars.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 Cyberspace management system
10, 10a Server
15 Database (DB)
20 Terminal device
30 Wearable device
111, 111a Acquisition unit
112, 112a Behavior recognition unit
113, 113a Context prediction unit
114, 114a Output unit

What is claimed is:

1. A context prediction device comprising:
at least one memory configured to store instructions; and
at least one processor configured to execute the instructions to:
acquire state information regarding a plurality of avatars and a plurality of virtual objects;
acquire motion information regarding the plurality of avatars and the plurality of virtual objects by user operations;
recognize behaviors of the plurality of avatars based on the state information and the motion information; and
predict contexts regarding the behaviors of the plurality of avatars based on the state information, the motion information, and the behaviors of the plurality of avatars.

2. The context prediction device according to claim 1,
wherein the at least one processor acquires multimodal information from a user,
wherein the at least one processor predicts the contexts regarding the behaviors of the plurality of avatars based on the state information, the motion information, the behaviors of the plurality of avatars, and the multimodal information.

3. The context prediction device according to claim 2,
wherein the at least one processor determines whether a content of the context is positive or negative; and
wherein the at least one processor performs notification to a system administrator and an avatar that has performed a negative behavior in a case where the content of the context is negative.

4. The context prediction device according to claim 3, wherein the at least one processor gives an incentive to an avatar that has performed a positive behavior in a case where the content of the context is positive.

5. The context prediction device according to claim 2, wherein the at least one processor estimates a state or an emotion of a user based on the content of the context and reflects the state or the emotion of the user in an avatar.

6. A context prediction method comprising:
acquiring state information regarding a plurality of avatars and a plurality of virtual objects;
acquiring motion information regarding the plurality of avatars and the plurality of virtual objects by user operations;
recognizing behaviors of the plurality of avatars based on the state information and the motion information; and
predicting contexts regarding the behaviors of the plurality of avatars based on the state information, the motion information, and the behaviors of the plurality of avatars.

7. A non-transitory computer readable recording medium recording a program for causing a computer to execute processing comprising:
acquiring state information regarding a plurality of avatars and a plurality of virtual objects;
acquiring motion information regarding the plurality of avatars and the plurality of virtual objects by user operations;
recognizing behaviors of the plurality of avatars based on the state information and the motion information; and
predicting contexts regarding the behaviors of the plurality of avatars based on the state information, the motion information, and the behaviors of the plurality of avatars.
